(19) United States
(12) Patent Application Publication
(10) Pub. No.: US 2026/0166954 A1
(43) Pub. Date: Jun. 18, 2026

(54) Method for Efficient Thermal Management of a Vehicle and a System Thereof

(71) Applicant: Daimler Truck AG, Leinfelden-Echterdingen (DE)

(72) Inventors: Sunil MEDURI, Bangalore (IN); Babu Rao PONANGI, Bangalore (IN); Praveen PUDOTA, Bangalore (IN); Anandu J, Bangalore (IN)

(21) Appl. No.: 19/407,650

(22) Filed: Dec. 3, 2025

(30) Foreign Application Priority Data
Dec. 18, 2024 (IN) 202441100377

(51) Int. Cl. B60H 1/00

(52) U.S. Cl. CPC B60H 1/00878

(57) ABSTRACT

A method and system for achieving energy-efficient thermal management in a vehicle by dynamically controlling the compressor's speed using a two-stage fuzzy logic-based approach. The method includes first receiving primary input parameters from the Electronic Control Unit (ECU) and determining an initial compressor speed using a first fuzzy controller. A simulated plant model may then calculate the power output ratio, providing intermediary parameters to assess the vehicle's power consumption. Based on the initial speed and power output ratio, a second fuzzy controller may then determine the final compressor speed required to meet predefined cooling requirements while maintaining optimal energy efficiency. The compressor may then subsequently be operated at the determined final speed, ensuring effective thermal management for vehicle components while minimizing power consumption. The method balances cooling performance with energy efficiency, enhancing the vehicle's overall operational effectiveness.

### CROSS REFERENCE TO RELATED APPLICATION

This application claims priority under 35 U.S.C. § 119 from Indian Patent Application No. 202441100377, filed Dec. 18, 2024, the entire disclosure of which is herein expressly incorporated by reference.

### BACKGROUND AND SUMMARY OF THE INVENTION

The following specification particularly describes the invention and the manner in which it is to be performed:

The present invention generally relates to the field of vehicles and more particularly relates to a method and system for ensuring energy-efficient thermal management in an electric vehicle.

The following description includes information that may be useful in understanding the present invention. It is not an admission that any of the information provided herein is prior art or relevant to the presently claimed invention, or that any publication specifically or implicitly referenced is prior art.

In today's world, electric vehicles (EVs) are increasingly becoming crucial for reducing dependency on fossil fuels, lowering energy costs, promoting energy security, advancing technology innovation, and supporting the transition to a sustainable transportation future. However, EVs face several challenges related to Heating, Ventilation, and Air Conditioning (HVAC), primarily due to their reliance on battery power.

In particular, EVs face challenges, particularly in managing both cabin and battery cooling in hot ambient conditions. Ideally, the HVAC system must efficiently cool the cabin to ensure passenger comfort while also regulating the battery temperature to prevent overheating and maintain optimal performance. This dual requirement may strain the vehicle's limited battery power, especially in high temperatures, which may lead to reduced driving range. Additionally, the HVAC system may also be inefficient due to speed fluctuations, and ambient temperature. Balancing these factors while maintaining energy efficiency and comfort is a significant challenge for EV HVAC systems, in the current times.

There is therefore a need for a method and system to overcome the above challenges associated with the existing technologies and to provide robust techniques for ensuring energy-efficient thermal management in any given EV.

The present disclosure overcomes one or more shortcomings of the prior art and provides additional advantages. Embodiments and aspects of the disclosure described in detail herein are considered a part of the claimed disclosure.

In one embodiment of the present disclosure, a method for facilitating an energy-efficient thermal management in a vehicle has been disclosed. The method comprises receiving, from an Electronic Control Unit (ECU) of the vehicle, a plurality of primary input parameters. Subsequently, the method comprises determining, by the ECU, an initial speed of a compressor in the vehicle by analysing the plurality of primary input parameters using a first fuzzy controller. Further, the method comprises deploying, by the ECU, a plant model to determine a power output ratio of the compressor based on the initial compressor speed. The plant model is a simulated framework for providing a plurality of intermediary parameters of the vehicle to determine the power output ratio. The power output ratio may indicate an electrical power input given to the compressor against a thermal power output generated from the compressor. Furthermore, the method comprises determining, by the ECU, a final speed of the compressor, required for achieving predefined cooling requirements for a plurality of components of the vehicle at a target optimal power consumption of the vehicle, using a second fuzzy controller. Finally, the method comprises operating, by the ECU, the compressor at the final speed, thereby achieving the predefined cooling requirements for the plurality of components at the optimal power consumption.

In yet another non-limiting embodiment of the present disclosure, the method further comprises determining an initial power consumption of the vehicle when the compressor is operating in the initial speed. Furthermore, the method comprises determining the target optimal power consumption based on the initial power consumption and a plurality of secondary input parameters.

In yet another non-limiting embodiment of the present disclosure, the plurality of primary input parameters comprises at least one of temperature of a battery of the vehicle and temperature of a cabin of the vehicle. The final speed of the compressor is determined based on a plurality of secondary input parameters. The plurality of secondary input parameters comprises at least one of the initial speed of the compressor, the power output ratio, a pre-defined condenser pressure threshold and a pre-defined chiller pressure threshold. The plurality of intermediary parameters comprises at least one of thermal load of the cabin, thermal load of a chiller and electrical power of the compressor. The plurality of components of the vehicle comprises at least one of the battery of the vehicle and the cabin of the vehicle. Regulating the temperature of the cabin is prioritized over regulating the temperature of the battery.

In yet another non-limiting embodiment of the present disclosure, the power consumption of the vehicle is determined based on a plurality of simulated parameters. The plurality of simulated parameters comprises at least one of an electrical power of the compressor, the thermal load of the cabin of the vehicle and the thermal load of the chiller of the vehicle.

In yet another non-limiting embodiment of the present disclosure, the method further comprises determining the final speed of the compressor as a trade-off between the predefined cooling requirements of the plurality of components and the power output ratio.

In yet another embodiment of the present disclosure, a system to facilitate an energy-efficient thermal management in a vehicle has been disclosed. The system comprises an Electronic Control Unit (ECU), a compressor, a memory and a processor. The processor, in conjunction with the ECU, is configured to receive a plurality of primary input parameters. The processor is further configured to determine an initial speed of the compressor in the vehicle by analysing the plurality of primary input parameters using a first fuzzy controller. Furthermore, the processor is configured to deploy a plant model to determine a power output ratio of the compressor based on the initial compressor speed. The plant model is a simulated framework to provide a plurality of intermediary parameters of the vehicle to determine the power output ratio. The power output ratio may indicate an electrical power input given to the compressor against a thermal power output generated from the compressor. Additionally, the processor is configured to determine a final speed of the compressor, required for achieving predefined cooling requirements for a plurality of components of the vehicle at a target optimal power consumption of the vehicle, using a second fuzzy controller. Lastly, the processor is configured to operate the compressor at the final speed, thereby achieving the predefined cooling requirements for the plurality of components at the optimal power consumption.

In yet another embodiment of the present disclosure, the processor is further configured to determine an initial power consumption of the vehicle when the compressor is operating in the initial speed. Furthermore, the processor is configured to determine the target optimal power consumption based on the initial power consumption and a plurality of secondary input parameters.

The foregoing summary is illustrative only and is not intended to be in any way limiting. In addition to the illustrative aspects, embodiments, and features described above, further aspects, embodiments, and features will become apparent by reference to the drawings and the following detailed description.

The features, nature, and advantages of the present disclosure will become more apparent from the detailed description set forth below when taken in conjunction with the drawings in which like reference characters identify correspondingly throughout. Some embodiments of system and/or methods in accordance with embodiments of the present subject matter are now described, by way of example only, and with reference to the accompanying figures.

### BRIEF DESCRIPTION OF DRAWINGS

FIG. 1 depicts an exemplary environment illustrating an vehicle and its related components, in accordance with embodiments of the present disclosure;

FIG. 2A depicts an exemplary process flow illustrating a technique for facilitating energy-efficient thermal management in the vehicle, in accordance with embodiments of the present disclosure;

FIG. 2B depicts an elaborated flow diagram illustrating the technique for facilitating energy-efficient thermal management in the vehicle, in accordance with embodiments of the present disclosure;

FIG. 3A depicts an exemplary graphical representation of various primary input parameters, in accordance with embodiments of the present disclosure;

FIG. 3B depicts an exemplary graphical representation of various secondary input parameters, in accordance with embodiments of the present disclosure;

FIG. 4 depicts a block diagram of a system configured to facilitate energy-efficient thermal management in the vehicle, in accordance with embodiments of the present disclosure; and

FIG. 5 is a flowchart showing steps of a method for facilitating the energy efficient thermal management in the vehicle, in accordance with embodiments of the present disclosure.

### DETAILED DESCRIPTION OF THE DRAWINGS

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in a computer readable medium and executed by a computer or processor, whether or not such computer or processor is explicitly shown.

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the spirit and the scope of the disclosure.

The terms “comprise”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to” unless expressly specified otherwise.

The terms “energy-efficiency” and “power-efficiency” have been used interchangeably in the present disclosure.

The terms “system” and “cooling system” have been used interchangeably in the present disclosure.

The terms “vehicle”, “electric vehicle”, “EV” and “Fuel Cell Electric Vehicle (FCEV)” have been used interchangeably in the present disclosure.

The terms “initial compressor speed”, “initial speed” and “initial output” have been used interchangeably in the present disclosure.

The terms “final compressor speed”, “final speed” and “final output” have been used interchangeably in the present disclosure

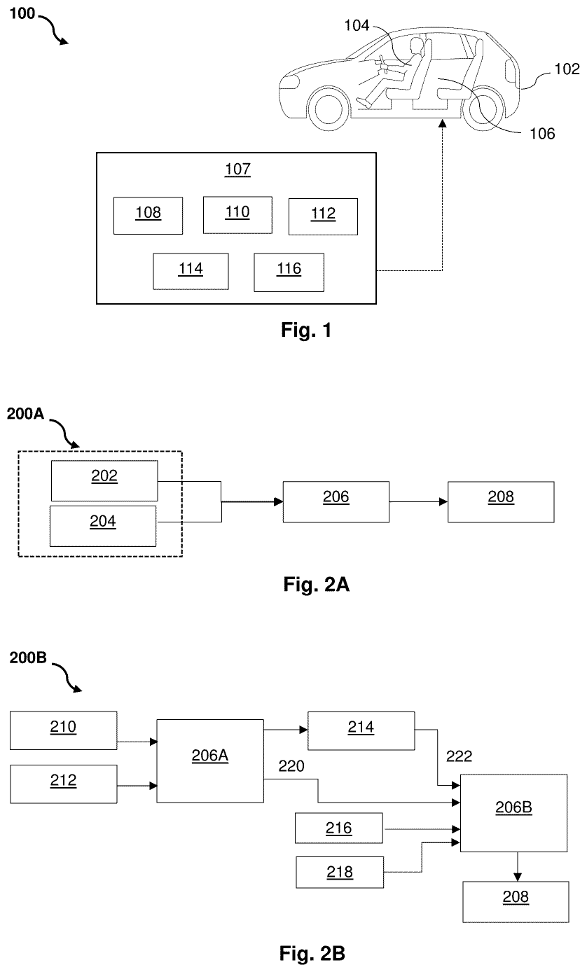

FIG. 1 depicts an exemplary environment 100 illustrating a vehicle 102 and one or more components 107 of the vehicle 102, configured to provide cooling to both a cabin 106 and a battery 112 or battery compartment of the vehicle 102, in accordance with embodiments of the present disclosure. Particularly, the FIG. 1 illustrates a driver 104, sitting in the cabin 106 of the vehicle 102 and driving the vehicle 102. In one embodiment, the components 107 may include, without limiting to, a power source 108, a Heating, Ventilation, and Air Conditioning (HVAC) system 110, the battery 112, a coolant circuit 114 and a refrigerant circuit 116.

In an embodiment, the battery 112, the coolant circuit 114 and the refrigerant circuit 116 may be responsible for maintaining an optimal thermal condition in the cabin 106 and the battery 112 or the battery compartment. In any given scenario, the driver 104 may dictate the HVAC operation, using a control interface provided on a dashboard or a cabin 106 of the vehicle 102 to modify the cooling in the cabin 106 based on the real-time requirements. In one embodiment, a PID (Proportional-Integral-Derivative) controller may regulate the HVAC system 110 to control parameters like battery temperature (BT), cabin temperature (CT), and compressor speed (ERC). In particular, the compressor speed may be adjusted dynamically to meet the cooling needs of both the cabin 106 and the battery 112 simultaneously. In one embodiment, the refrigerant circuit 116 may further comprise of additional components including, without limiting to, a condenser and a chiller, which may be configured to provide a required cooling in the cabin 106 by transferring excess heat away from the cabin 106. Similarly, the coolant circuit 114 may facilitate cooling of the battery 112 through a heat exchanger. The HVAC system 110 may also incorporate feedback loops to monitor critical variables such as condenser pressure and chiller pressure, ensuring efficient operation of the refrigerant circuit 116.

In particular, cooling is achieved by integrating the thermal demands of the battery 112 and the cabin 106 through a centralized control mechanism. The PID controller, in one embodiment, may play a critical role in managing the cooling process by receiving input signals corresponding to the thermal demand of the battery 112 and the cooling requirement of the cabin 106. The proposed system may then use the received inputs to regulate the operation of the compressor, ensuring that the appropriate amount of cooling is delivered to the cabin 106 and/or the battery 112 of the vehicle 102 as and when required. The HVAC system 110, in turn, may work by circulating refrigerant through the refrigerant circuit 116 that may further include components like a condenser, evaporator, and chiller. For the battery 112, the coolant circuit 114 may be used to transfer heat from the battery pack to the refrigerant loop via a chiller, effectively dissipating excess heat generated during operation of the battery 112. Further, for the cabin 106, the refrigerant circuit 116 may directly cool the cabin air, maintaining a comfortable temperature for passengers. In addition to maintaining the temperature, the PID controller may also be configured to ensure that the compressor speed is adjusted dynamically based on real-time cooling requirements. However, in scenarios where both the battery 112 and the cabin 106 demand significant cooling simultaneously, priorities may be decided based on predefined thresholds, which may compromise either passenger comfort or battery safety under certain conditions. Further, the power source 108, which may be an internal combustion engine, hybrid engine, or battery pack but not limited thereto, play a crucial role in powering the components of the vehicle 102 including the HVAC system 110, coolant circuit, and refrigerant circuit. The power source 108 may supply the energy needed to drive the compressor, fans, and pumps among others which are essential for maintaining optimal temperatures in both the cabin 106 and the battery 112. Additionally, the power source 108 may support efficient energy use by enabling the PID controller to dynamically adjust cooling parameters based on real-time demands, ensuring a balance between passenger comfort and battery safety.

The solution proposed in the present disclosure helps in balancing the cooling demands of both the cabin 106 and the battery 112, which may, in turn, lead to efficient management of power consumption in the vehicle 102, thereby improving the driving range of the vehicle 102. In other words, the present disclosure provides techniques for ensuring energy efficient thermal management in the vehicle 102 as discussed in the forthcoming paragraphs, in conjunction with FIGS. 2-5 of the present disclosure.

FIG. 2A depicts an exemplary process flow 200A illustrating a technique for facilitating energy-efficient thermal management in a vehicle 102, in accordance with embodiments of the present disclosure. Particularly, FIG. 2A illustrates a fuzzy controller 206, which may take a plurality of inputs to determine an “optimum” compressor speed for enabling the energy-efficient thermal management of the vehicle 102. In one embodiment, the fuzzy controller 206 maybe an intelligent control system that uses fuzzy logic to manage the cooling requirements of both the battery 112 and the cabin 106 in the vehicle 102. Unlike traditional controllers that rely on precise mathematical models, the fuzzy controller 206 may operate based on human-like reasoning by using a set of predefined rules and linguistic variables such as “low,” “medium,” or “high”. In an embodiment, the fuzzy controller 206 may take a variety of inputs, which may include battery demand 202 and cabin demand 204, but no limited thereto. The battery demand 202 and the cabin demand 204 may further include parameters such as battery temperature and cabin temperature, as well as safety parameters like condenser threshold and chiller threshold, which have been discussed in detail in the forthcoming paragraphs in conjunction with FIG. 2B of the present disclosure.

Referring again to FIG. 2A, the fuzzy controller 206 may dynamically adjust the compressor speed and provide a final output 208 by evaluating the variety of inputs by ensuring that the cooling demands are met efficiently while maintaining safe operating conditions. In yet another embodiment, the fuzzy controller 206 may comprise a two-stage fuzzification process for determining the compressor speed using the cabin temperature and the battery temperature (i.e., stage 1 of the fuzzy controller 206) and refining it by ensuring the safety thresholds for the condenser and the chiller (i.e., stage 2 of the fuzzy controller 206) while also incorporating inputs from a simulated framework. The two-stage fuzzification is illustrated in detail in FIG. 2B of the present disclosure.

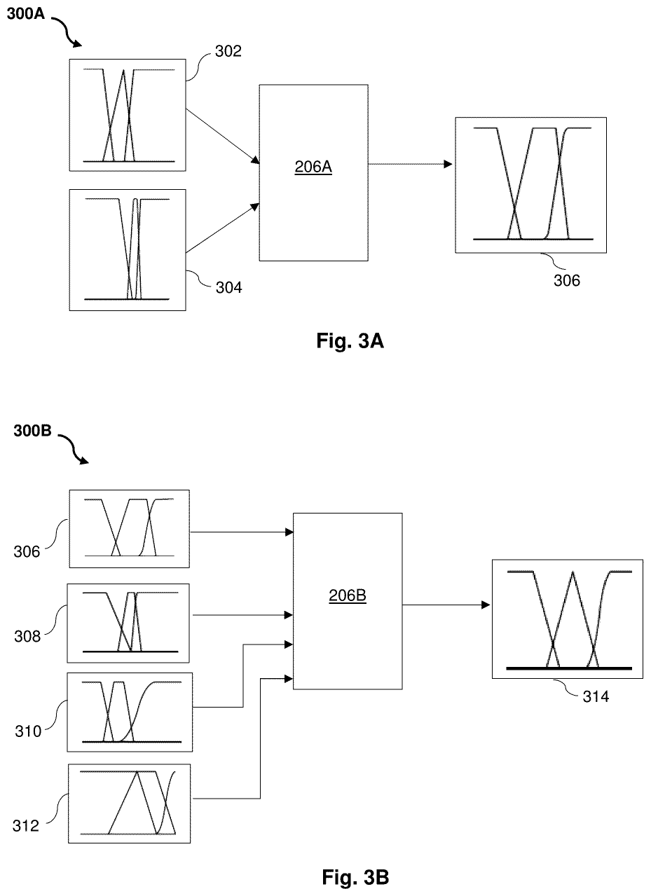

FIG. 2B depicts an elaborated flow diagram 200B illustrating the technique for facilitating energy-efficient thermal management in a vehicle 102, in accordance with embodiments of the present disclosure. FIG. 2B may be referred to as an expanded version of FIG. 2A, where the fuzzy controller 206 depicted in FIG. 2A is expanded and depicted as a first fuzzy controller 206A and a second fuzzy controller 206B. In one embodiment, the first fuzzy controller 206A may be depicting the first stage of fuzzification and the second fuzzy controller 206B may be depicting the second stage of fuzzification. In addition, the variety of inputs have also been expanded at both stages of the fuzzification process. At the first stage, a plurality of primary input parameters may be fed to the first fuzzy controller 206A. The primary input parameters may include, without limiting to, battery temperature 210 and cabin temperature 212 of the vehicle 102. Based on the primary input parameters, the first fuzzy controller 206A may determine an initial speed 220 of the compressor of the vehicle 102. A more detailed explanation about an inter-relation between the primary input parameters and the initial speed 220 is provided in the forthcoming paragraphs in conjunction with FIG. 3A of the present disclosure.

FIG. 3A depicts an exemplary graphical representation 300A of various primary input parameters, in accordance with embodiments of the present disclosure. The FIG. 3A may illustrate a battery temperature graphical representation 302 and a cabin temperature graphical representation 304 such that, at different scenarios, corresponding battery temperature 202 and cabin temperature 204 being “high”, “optimum” or “low” are depicted. Based on the primary input parameter received, the first fuzzy controller 206A may determine an initial speed 220 of the compressor, which may be illustrated as initial speed graphical representation 306. In one embodiment, the initial speed graphical representation 306 may be a result of the input received from the battery temperature graphical representation 302 and cabin temperature graphical representation 304 based on a variety of rules, such that the rules may be designed to manage the system based on the conditions of the cabin temperature 204 and the battery temperature 202. Each of the rules may define a condition and the corresponding output, which have been discussed in the upcoming paragraphs.

In one embodiment, a first rule may state that, if the cabin temperature 204 is “low” and the battery temperature 202 is “high”, then the initial speed 220 should be set to “high”. The first rule may therefore imply that the “high” battery temperature 202 under “low” cabin 106 conditions may require more energy regulation. In another embodiment, a second rule may indicate that, if the cabin temperature 204 is “low” and the battery temperature 202 is “optimal”, then the initial speed 220 should also be “medium”, suggesting that maintaining “low” cabin temperature 204, while ensuring energy regulation is important even when the battery 112 is at an ideal temperature. In yet another embodiment, a third rule may suggest that, if the cabin temperature 204 is “low” and the battery temperature 202 is also “low”, the initial speed 220 should be set to “low”, indicating that “low” temperature in both the cabin 106 and the battery 112 region may not require operating the compressor at a “high” speed. In yet another embodiment, a fourth rule may state that, if the cabin temperature 204 is “high” and the battery temperature 202 is also “high”, the initial speed 220 of the compressor should be “high”. This may suggest that “high” temperature in both the cabin 106 and the battery 112 region requires more energy intervention and therefore “high” initial compressor speed may be maintained. In yet another embodiment, a fifth rule may highlight that, if the cabin temperature 204 is “high” and the battery temperature 202 is “optimal”, then the initial speed 220 should be “high”, indicating a need for regulation to manage the “high” cabin temperature 204. In yet another embodiment, a sixth rule may specify that, if the cabin temperature 204 is “high” and the battery temperature is “low” 202, the initial speed 220 should be “high”, reflecting that maintain a low cabin temperature is of utmost priority under any given condition. In yet another embodiment, a seventh rule may state that, if the cabin temperature 204 is “optimal” and the battery temperature 202 is “high”, then the initial speed 220 should be “high”, which may indicate a focus on maintaining optimal temperature conditions for both the cabin 106 and the battery 112, while ensuring power efficiency. In yet another embodiment, an eighth rule may suggest that if the cabin temperature 204 is “optimal” and the battery temperature 202 is “low”, the initial speed 220 should be “low, suggesting a minimal need for regulation, thus ensuring energy efficiency. The above discussed rules may collectively allow the fuzzy controller 206 to adaptively manage energy regulation based on varying temperature conditions in the cabin 106 and the battery 112, ensuring efficient operation while always prioritizing the ambient cabin temperature 204 over the battery temperature 202. In one embodiment, if both the cabin 106 and the battery 112 require cooling to bring down the associated temperature conditions, the cooling requirements of the cabin 106 may always be prioritized.

Once the initial speed 220 is determined, it may be fed as an input to the second fuzzy controller 206B along with a plurality of secondary parameters. In one embodiment, the plurality of secondary parameters may include a pre-defined condenser pressure threshold 216 and a pre-defined chiller pressure threshold 218 along with inputs from a simulated framework, also referred to as a plant model 214. In one embodiment, the plant model 214 may be a comprehensive simulation or imitation framework of the vehicle's 102 cooling mechanism, which may imitate working of various components 107 of the vehicle 102, such as the battery 112, the cabin 106, compressor, condenser, and chiller, among others. In particular, inclusion of the simulated framework, such as the plant model 214 may enhance the efficiency and robustness of determining the final compressor speed by providing a reliable representation of the cooling mechanism under various operating conditions. By imitating real-world scenarios, the plant model 214 may allow for precise adjustments to the compressor speed based on accurate predictions of system behaviour. The plant model 214 may therefore reduce reliance on trial-and-error methods and ensure that the cooling mechanism may operate optimally under diverse conditions The plant model 214 may receive multiple real-time inputs, including battery temperature 210 and cabin temperature 212, the initial compressor speed 220, and safety thresholds for critical components like the condenser and chiller. Using the inputs, the plant model 214 may determine the relationship between power consumption and thermal load of the vehicle 102 thereby enabling the proposed system to optimize energy consumption in the vehicle 102. In particular, the plant model 214 may contribute to determining a power output ratio 222 of the vehicle 102 by simulating the relationship between the thermal load and the power consumed by the compressor. The plant model 214 may determine how much power the system may require to meet the cooling demands of both the battery 112 and the cabin 106 while considering safety thresholds and thermal limits. In one embodiment, the plant model 214 may determine the power output ratio 222 by providing a plurality of intermediary parameters, which may include thermal load of the cabin 106, thermal load of a chiller and electric power of the compressor among others. By accurately predicting the power output ratio 222, the plant model 214 may thereby help in regulating the compressor speed in an optimal range, ensuring that only the necessary amount of power is consumed for effective cooling, thereby contributing to efficient power consumption in the vehicle 102. Accordingly, the plant model 214 also helps in reducing energy wastage, prolonging the range of the high-voltage battery 112, and maintaining thermal balance with minimal power usage. The plant model 214 may therefore, play a crucial role by predicting and balancing the cooling requirements, while minimizing energy use through precise modelling of real-world conditions.

The second fuzzy controller 206B may receive the power output ratio 222, the initial speed 220, the pre-defined condenser pressure threshold 216 and the pre-defined chiller pressure threshold 218, among other parameters, as the input and determine a final output 208 indicating a final compressor speed for meeting the cooling requirements of the vehicle 102. The load on the compressor may be determined by various factors such as condenser pressure, ambient temperature, and the thermal load on the system among others. So, the initial speed 220 and the condenser pressure may be interconnected as part of the thermal management mechanism of the vehicle 102, directly influencing each other and the final speed to balance the cooling performance and overall power efficiency.

In an embodiment, a higher initial speed 220 may increase the refrigerant flow, raising the condenser pressure due to the higher thermal load, while lower initial speed 220 may reduce the flow and pressure. The system may therefore dynamically adjust the final speed based on the condenser pressure. That is, at a high condenser pressure, the final speed may be reduced to prevent excessive energy consumption and stabilize the system, whereas at low condenser pressure, the final speed may remain higher to maintain adequate cooling with minimal energy use. When the pressure is optimal, the final speed may be set to efficiently balance power use and thermal performance. This adaptive approach may ensure efficient energy utilization while maintaining effective cooling under varying thermal loads. A more detailed explanation about the inter-relation between the secondary input parameters and the final speed has been provided in the forthcoming paragraphs in conjunction with FIG. 3B of the present disclosure.

FIG. 3B depicts an exemplary graphical representation 300B of various secondary input parameters, in accordance with embodiments of the present disclosure. The FIG. 3B may illustrate an initial speed graphical representation 306, a condenser pressure graphical representation 308, a chiller pressure graphical representation 310 and a power output ratio graphical representation 312 such that at different scenarios, the corresponding secondary input parameters being “high”, “optimum” or “low” are depicted. Based on the secondary input parameter received, the second fuzzy controller 206B may determine the final speed, which may be illustrated as the final speed graphical representation 314. In one embodiment, the final speed graphical representation 314 may be a result of the input received from the initial speed graphical representation 306, the condenser pressure graphical representation 308, the chiller pressure graphical representation 310 and the power output ratio graphical representation 312 based on a variety of rules such that these rules may be designed to manage the system based on the conditions of the cabin temperature 204 and the battery temperature 202. Each of the rules may define a condition and a corresponding output, as discussed in the upcoming paragraphs.

In one embodiment, a first rule may indicate that when both the initial speed 220 and condenser pressure are high, it may result in “low” final speed to meet the safety requirements under excessive thermal pressure conditions. In another embodiment, a second rule may indicate that, when the initial speed 220 is “high” and the condenser pressure is optimum, then the final speed may be maintained “high”, ensuring effective cooling without overburdening the condenser. In yet another embodiment, a third rule may indicate that when the initial speed 220 is “high” with “low” condenser pressure, the final speed may be kept “high” to maximize cooling efficiency when the thermal demand is high. In yet another embodiment, a fourth rule may suggest that when the initial speed 220 is optimum and the condenser pressure is “low”, the final speed may be set to “medium” thereby balancing energy efficiency and cooling demand during reduced thermal loads. In yet another embodiment, a fifth rule may suggest that when both the initial speed 220 and the condenser pressure are “optimum”, the final speed may be kept at “medium” for sustaining steady cooling with moderate energy usage. In yet another embodiment, a sixth rule may suggest that when the initial speed 220 is “optimum” and the condenser pressure is “high”, the final speed may be kept low to meet safety requirements while managing “medium” thermal loads. In yet another embodiment, a seventh rule may suggest that when both the initial speed 220 and the condenser pressure are “low”, it may result in a “low” final speed, thereby optimizing power use while addressing minimal thermal loads. In yet another embodiment, an eighth rule may suggest that, when the initial speed 220 is “low” and the condenser pressure is “optimum”, the final speed may be maintained at “low” for conserving energy during efficient cooling conditions. In yet another embodiment, a ninth rule may suggest that when the initial speed 220 is “low” and the condenser pressure is “high”, the final speed may be limited to “low” to prevent overloading the system while ensuring minimal cooling. In an embodiment, various rules explained above are exemplary and non-limiting, and any other rules may be implemented to ensure an energy-efficient cooling in the vehicle 102.

In an embodiment, the final speed may be determined from the chiller pressure, which may represent the refrigerant pressure on the low-pressure side of the cooling system, directly linked to the compressor's performance and thermal load. Lower chiller pressure may indicate effective heat absorption but reduced cooling demand, while higher chiller pressure may reflect insufficient cooling or higher thermal loads. The system may thereby adjust the final compressor speed dynamically based on the chiller pressure to balance thermal management and power efficiency. “low” chiller pressure may allow the compressor to operate at a reduced speed to conserve energy, while higher chiller pressure may demand a higher final speed to restore effective cooling. To accommodate the chiller pressure effectively while determining the final speed, some additional rules may be established, which have been discussed in the upcoming paragraphs.

In one embodiment, a tenth rule may indicate that when the chiller pressure is “low”, the final speed is also “low”. The tenth rule may therefore indicate that when the chiller pressure is “low”, it may lead to sub-optimal performance for the chiller. To maintain power efficiency, the system may lower the final speed for minimizing the hazards associated with operation of the chiller at “low” pressure. In another embodiment, an eleventh rule may indicate that when the chiller pressure is “optimum”, then the final speed may be higher thus indicating that with “optimum” chiller pressure, the cooling mechanism may be operating efficiently. To sustain optimal thermal management, the system may increase in the final speed, ensuring adequate cooling performance without excessive energy consumption. In yet another embodiment, a twelfth rule may suggest that when the chiller pressure is “high”, the final speed is also “high” thus indicating that the “high” chiller pressure may increase thermal demand. To address this, the system may thereby raise the final speed for enhancing refrigerant flow to restore effective cooling while prioritizing the system performance. In one embodiment, in thirteenth rule, both the condenser pressure and the chiller pressure may be considered together to determine the final speed such that when the condenser pressure is “high” and the chiller pressure is “low”, it may signal the sub-optimal performance of the chiller in the refrigerant cycle, where heat dissipation in the condenser is inefficient, but cooling demand at the chiller side is reduced. To maintain power efficiency and avoid overloading the system, the final speed may be lowered to minimize refrigerant flow, stabilize pressures, and optimize energy use while still addressing thermal requirements.

Further, the power output ratio 222 may indicate electrical power input given to the compressor against thermal power output generated from the compressor. Therefore, a high-power output ratio may indicate that more energy may be required for managing the lower thermal loads, which may lead to inefficient utilization of energy. Conversely, a “low” power output ratio may mean less energy may be required for handling higher thermal loads indicating energy-efficient state of the vehicle 102. The final speed may thereby be adjusted dynamically based on the power output ratio 222 to ensure effective thermal management without compromising overall power efficiency. To account for the power output ratio 222 effectively while determining the final speed, some additional rules may be established, as discussed in the upcoming paragraphs.

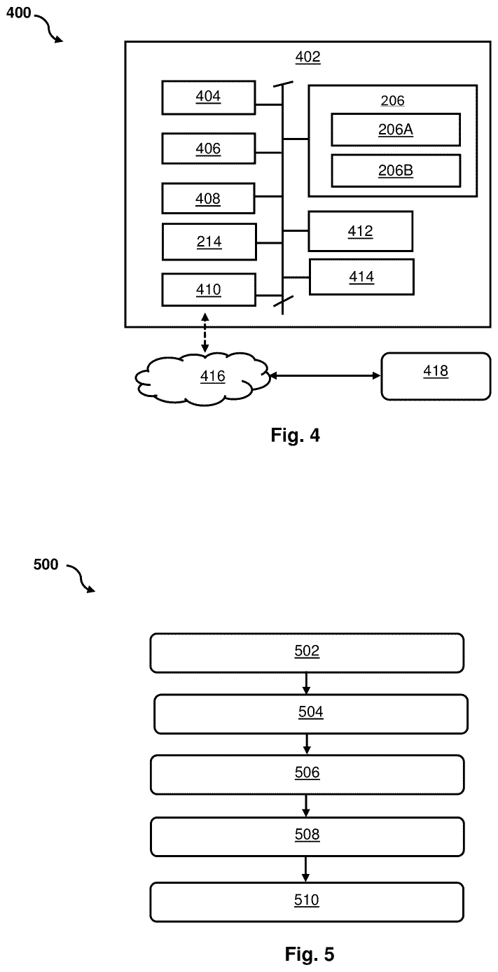

In one embodiment, a fourteenth rule may indicate that when the power output ratio 222 is “low” then the final speed may also be maintained at lower end. The fourteenth rule may therefore indicate that the “low” power output ratio may mean low energy may be required for managing higher thermal load. In another embodiment, a fifteenth rule may indicate that, when the power output ratio 222 is “high”, the final speed may be maintained at higher end. The fifteenth rule may therefore indicate that the high-power output ratio may reflect high energy being consumed for managing the lower thermal loads. In yet another embodiment, a sixteenth rule may indicate that when the power output ratio 222 is “optimum”, the final speed may be maintained at optimal end. The sixteenth rule may therefore indicate that with an “optimum” power output ratio, there may be a balanced distribution of energy as the optimum amount of energy may be required for managing the optimum thermal load. The final speed may therefore be set to a “medium” or “low” level, maintaining adequate cooling without overloading the system or compromising energy efficiency. The system to implement the above discussed process has been explained in the upcoming paragraphs in conjunction with FIG. 4 of the present disclosure.

FIG. 4 depicts a block diagram 400 of a system 402 configured to facilitate energy-efficient thermal management in the vehicle 102, in accordance with embodiments of the present disclosure. In an implementation, the system 402 may include, without limiting to, an Input/Output (I/O) interface 404, a memory 406, a processor 408, a network interface 410, a fuzzy controller 206, an Electronic Control Unit (ECU) 412 and a plant model 214. FIG. 4 further illustrates an interaction between the system 402 with a server 418 via a communication network 416. The fuzzy controller 206, in one embodiment, may further comprise the first fuzzy controller 206A and the second fuzzy controller 206B.

In one embodiment, the system 402 may be configured to ensure energy-efficient thermal management in the vehicle 102 through the two-stage fuzzy controller 206. The I/O interface 404 may facilitate data exchange between external components such as sensors and the system 402 such that, in one embodiment, the I/O interface 404 may collect inputs like ambient temperature, pressure, and power demand of the vehicle 102. In another embodiment, the I/O interface 404, in conjunction with the ECU 412, may also collect the primary input parameter. Also, the ECU 412 may be configured to collect the data related to the battery temperature 210 and the cabin temperature 212. The primary input parameters may then be processed via the processor 408 and stored in the memory 406. In one embodiment, the memory 406 may further store a plant model 214 (i.e., the simulated framework) along with a plurality of rules associated with the operation of the plant model 214. In another embodiment, the plant model 214, along with the corresponding rules, may also be stored at the server 418, which may be accessed by the communication network 416 with the help of the network interface 410. Once the data associated with the primary input parameters is stored in the memory, the processor 408 may be further configured to run the thermal management framework, leveraging the fuzzy controller 206 to dynamically optimize the cooling and energy usage. The first fuzzy controller 206A may be configured to evaluate real-time data associated with the primary input parameters such as the battery temperature 210 and the cabin temperature 212 to determine an initial speed 220 of the compressor. Subsequently, the processor 408, in conjunction with the plant model 214, may be configured to receive the initial speed 220 and determine a power output ratio 222 for estimating the power consumption of the vehicle 102. In one embodiment, the plant model 214 may be configured to determine the power output ratio 222 based on a variety of intermediary parameters such as thermal load of the cabin 206, thermal load of a chiller and electrical power of the compressor, but not limited thereto.

The ECU 412, in conjunction with the I/O interface 404, may be further configured to receive the secondary input parameters, such as the predetermined condenser pressure threshold 216 and the predetermined chiller pressure threshold 218 and provide the same to the processor 408. The processor 408, in turn, may provide the plurality of secondary parameters comprising the initial speed 220, the power output ratio 222 along with the predetermined condenser pressure threshold 216 and the predetermined chiller pressure threshold 218 to the second fuzzy controller 206B. The second fuzzy controller 206B may then determine the final speed of the compressor based on the received secondary input parameters for ensuring long-term thermal management of the vehicle 102, while simultaneously facilitating the efficient power consumption in the vehicle 102. In addition, the server 420 may also aid the system 402 in advanced analytics, updates, or predictive maintenance. Outputs, including system states or performance metrics, may also be displayed on a display unit 414 to enable monitoring and control by the driver 104 or any other operator of the vehicle 102.

FIG. 5 is a flowchart showing steps of a method 500 for facilitating the energy-efficient thermal management in a vehicle 102, in accordance with embodiments of the present disclosure. The method 500 may also be described in the general context of computer executable instructions. Generally, computer executable instructions may include routines, programs, objects, components, data structures, procedures, modules, and functions, which perform specific functions or implement specific abstract data types.

The order in which the method 500 is described is not intended to be construed as a limitation, and any number of the described method blocks may be combined in any order to implement the method. Additionally, individual blocks may be deleted from the methods without departing from the spirit and scope of the subject matter described.

At step 502, the method 500 may include receiving a plurality of primary input parameters. In one non-limiting embodiment, the plurality of primary input parameters may comprise data associated with battery temperature 210 and cabin temperature 212. The plurality of input parameters may be received from an Electronic Control Unit (ECU) 412 of a vehicle 102 via an I/O interface 404 of a system 402 of the vehicle 102.

At step 504, the method 500 may include determining an initial speed 220 of a compressor in the vehicle 102 by analysing the plurality of primary input parameters using a first fuzzy controller 206A. In one non-limiting embodiment, a processor 408 of the system 402, in conjunction with the ECU 412, may be configured to deploy first fuzzy controller 206A for determining the initial speed 220 of the compressor.

At step 506, the method 500 may include deploying a plant model 214 to determine a power output ratio 222 of the compressor based on the initial compressor speed 220. In one non-limiting embodiment, the plant model 214 may be a simulated framework for providing a plurality of intermediary parameters of the vehicle 102 to determine the power output ratio 222. In another embodiment, the plurality of intermediary parameters may comprise at least one of thermal load of a cabin 106 of the vehicle 102, thermal load of a chiller and an electrical power of the compressor. In yet another embodiment, the power output ratio 222 may indicate the power consumption by the vehicle 102. In yet another embodiment, the power consumption may be determined based on a plurality of simulated parameters such that the plurality of simulated parameters may comprise at least one of an electrical power of the compressor, a thermal power of cabin of the vehicle 102 and a thermal power of a chiller of the vehicle 102 but not limited thereto. In yet another embodiment, the processor 408, in conjunction with the ECU 412, may be configured to deploy the plant model 214 for determining the power output ratio 222.

At step 508, the method 500 may include determining a final speed of the compressor. In an embodiment, the final speed may be a speed with which the compressor must operate in order to achieve predefined cooling requirements for a plurality of components of the vehicle 102. In one embodiment, the processor 408, in conjunction with the ECU 412, may be configured to deploy a second fuzzy controller 206B for determining the final speed.

At step 510, the method 500 may include operating the compressor at the final speed for achieving the predefined cooling requirements for the plurality of components at the optimal power consumption. In one embodiment, the processor 408, in conjunction with the ECU 412, may be configured to operate the compressor at the determined final speed.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. It may be noted here that the subject matter of some or all embodiments described with reference to FIGS. 1-5 may be relevant for the method and the same is not repeated for the sake of brevity.

Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Further, any skilled person in the art would appreciate that the reconstruction error mentioned in the foregoing paragraphs may be considered as a value that overshoots the determined threshold value and must not be construed as an error as such.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

Suitable processors include, by way of example, a general-purpose processor, a special purpose processor, a conventional processor, a digital signal processor (DSP), a graphic processing unit (GPU), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE CHARACTERS

| Reference | |
|---|---|
| character | Label |
| 100 | Existing exemplary environment |
| 102 | Vehicle |
| 104 | Driver |
| 106 | Cabin |
| 107 | Components of the vehicle |
| 108 | Power source |
| 110 | HVAC System |
| 112 | Battery |
| 114 | Coolant Circuit |
| 116 | Refrigerant Circuit |
| 200A | Exemplary process flow |
| 202 | Battery demand |
| 204 | Cabin demand |
| 206 | Two-stage Fuzzy Controller |
| 206A | First Fuzzy controller |
| 206B | Second Fuzzy controller |
| 208 | Final Output |
| 200B | Elaborated flow diagram |
| 210 | Battery temperature |
| 212 | Cabin temperature |
| 214 | Plant model |
| 216 | Pre-defined condenser pressure threshold |
| 218 | Pre-defined chiller pressure threshold |
| 300A | Exemplary graphical representation |
| 300B | Exemplary graphical representation |
| 302 | Battery temperature graphical representation |
| 304 | Cabin temperature graphical representation |
| 306 | Initial speed graphical representation |
| 308 | Condenser pressure graphical representation |
| 310 | Chiller pressure graphical representation |
| 312 | Power output ratio graphical representation |
| 314 | Final speed graphical representation |
| 400 | Block diagram |
| 402 | System/ Cooling system |
| 404 | I/O Interface |
| 406 | Memory |
| 408 | Processor |
| 410 | Network Interface |
| 412 | ECU |
| 414 | Display Unit |
| 416 | Communication Network |
| 418 | Server |

What is claimed is:

1. A method for facilitating an energy-efficient thermal management in a vehicle, comprising the steps of:
receiving, from an Electronic Control Unit (ECU) of the vehicle, a plurality of primary input parameters;
determining, by the ECU, an initial speed of a compressor in the vehicle by analyzing the plurality of primary input parameters using a first fuzzy controller;
deploying, by the ECU, a plant model to determine a power output ratio of the compressor based on the initial speed of the compressor, wherein the plant model is a simulated framework for providing a plurality of intermediary parameters of the vehicle to determine the power output ratio and wherein the power output ratio indicates an electrical power input given to the compressor against a thermal power output generated from the compressor;
determining, by the ECU, a final speed of the compressor, required for achieving predefined cooling requirements for a plurality of components of the vehicle at a target optimal power consumption of the vehicle, using a second fuzzy controller; and
operating, by the ECU, the compressor at the final speed, thereby achieving the predefined cooling requirements.

2. The method as claimed in claim 1 further comprising the steps of:
determining an initial power consumption of the vehicle when the compressor is operating in the initial speed; and
determining the target optimal power consumption based on the initial power consumption and a plurality of secondary input parameters.

3. The method as claimed in claim 2, wherein:
the plurality of primary input parameters comprises at least one of a temperature of a battery of the vehicle and a temperature of a cabin of the vehicle and wherein the final speed of the compressor is determined based on the plurality of secondary input parameters;
the plurality of secondary input parameters comprises at least one of the initial speed of the compressor, the power output ratio, a pre-defined condenser pressure threshold and a pre-defined chiller pressure threshold;
the plurality of intermediary parameters comprises at least one of a thermal load of the cabin, a thermal load of a chiller, and an electrical power of the compressor; and
the plurality of components of the vehicle comprises at least one of the battery of the vehicle and the cabin of the vehicle, wherein regulating the temperature of the cabin is prioritized over regulating the temperature of the battery.

4. The method as claimed in claim 1, wherein a power consumption of the vehicle is determined based on a plurality of simulated parameters and wherein the plurality of simulated parameters comprises at least one of an electrical power of the compressor, a thermal load of a cabin of the vehicle and a thermal load of a chiller of the vehicle.

5. The method as claimed in claim 1, wherein the final speed of the compressor is determined as a trade-off between the predefined cooling requirements and the power output ratio.

6. A system to facilitate an energy-efficient thermal management in a vehicle, comprising:
an Electronic Control Unit (ECU);
a compressor;
a memory; and
a processor, wherein the processor in conjunction with the ECU is configured to:
receive a plurality of primary input parameters;
determine an initial speed of the compressor by analyzing the plurality of primary input parameters using a first fuzzy controller;
deploy a plant model to determine a power output ratio of the compressor based on the initial speed of the compressor, wherein the plant model is a simulated framework to provide a plurality of intermediary parameters of the vehicle to determine the power output ratio and wherein the power output ratio indicates an electrical power input given to the compressor against a thermal power output generated from the compressor;
determine a final speed of the compressor, required for achieving predefined cooling requirements for a plurality of components of the vehicle at a target optimal power consumption of the vehicle, using a second fuzzy controller; and
operate the compressor at the final speed, thereby achieving the predefined cooling requirements.

7. The system as claimed in claim 6, wherein the processor is further configured to:
determine an initial power consumption of the vehicle when the compressor is operating in the initial speed; and
determine the target optimal power consumption based on the initial power consumption and a plurality of secondary input parameters.

8. The system as claimed in claim 7, wherein:
the plurality of primary input parameters comprises at least one of a temperature of a battery of the vehicle and a temperature of a cabin of the vehicle and wherein the final speed of the compressor is determined based on a plurality of secondary input parameters;
the plurality of secondary input parameters comprises at least one of the initial speed of the compressor, the power output ratio, a pre-defined condenser pressure threshold and a pre-defined chiller pressure threshold;
the plurality of intermediary parameters comprises at least one of a thermal load of the cabin, a thermal load of a chiller and electrical power of the compressor; and
the plurality of components of the vehicle comprises at least one of the battery of the vehicle and the cabin of the vehicle, wherein regulating the temperature of the cabin is prioritized over regulating the temperature of the battery.

9. The system as claimed in claim 6, wherein a power consumption of the vehicle is determined based on a plurality of simulated parameters and wherein the plurality of simulated parameters comprises at least one of an electrical power of the compressor, a thermal load of a cabin of the vehicle and a thermal load of a chiller of the vehicle.

10. The system as claimed in claim 6, wherein the processor is configured to determine the final speed of the compressor as a trade-off between the predefined cooling requirements and the power output ratio.
